(19) United States
(12) Patent Application Publication
(10) Pub. No.: US 2016/0285813 A1
(43) Pub. Date: Sep. 29, 2016

(54) DELIVERING A PUBLICATION TO A SUBSCRIBER

(71) Applicant: HEWLETT-PACKARD DEVELOPMENT COMPANY, L.P., Houston, TX (US)

(72) Inventors: Dana E. LAURSEN, Corvallis, OR (US); Brian David GRANATIR, Vancouver, WA (US)

(21) Appl. No.: 15/033,694

(22) PCT Filed: Nov. 15, 2013
(86) PCT No.: PCT/US2013/070300

§ 371 Date: May 2, 2016

(51) Int. Cl. H04L 12/58

(52) U.S. Cl. CPC H04L 51/26; H04L 51/046

(57) ABSTRACT

A method for delivering a publication to a subscriber includes obtaining, from a content source, a group of currently available subscribed content pieces for a subscriber; determining if content pieces, from the group of currently available subscribed content pieces, are invalid content pieces; removing any invalid content pieces from the group; creating a publication with content pieces remaining in the group; and delivering the publication to the subscriber.

### BACKGROUND

Content pieces, such as articles or stories about news, sports, editorials, and other categories, may be included in a publication such as a newspaper or magazine. Some subscribers will have more interest in some subject categories than others. Often, the decision of a subscriber to subscribe to a publication will be based on the amount of content that publication offers that is in the interest areas of the subscriber.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for delivering a publication to a subscriber, according to principles described herein.

FIG. 2 is a diagram of an example of a delivery schedule, according to principles described herein.

FIG. 3 is a flowchart of an example of a method for delivering a publication to a subscriber, according to principles described herein.

FIG. 4 is a flowchart of an example of a method for removing invalid content pieces from a group of currently available subscribed content categories to create a group of up-to-date subscribed content categories, according to principles described herein.

FIG. 5 is a flowchart of an example of a method for determining if a content piece is a valid content piece for a subscriber, according to principles described herein.

FIG. 6 is a flowchart of an example of a method for delivering a publication, according to principles described herein.

FIG. 7 is a flowchart of an example of a method for delaying delivery of a publication, according to principles described herein.

FIG. 8 is a diagram of an example of a delivery system, according to principles described herein.

FIG. 9 is a diagram of an example of a delivery system, according to principles described herein.

Throughout the drawings, identical reference numbers designate similar, but not necessarily identical, elements.

### DETAILED DESCRIPTION

As mentioned above, a publication often includes content pieces in different subject categories that are of interest to a subscriber. With electronic publishing, a publication that includes content pieces that are of interest to a subscriber may be delivered according to a delivery schedule that is selected and set by the subscriber. Additionally, the publication can be personalized for each subscriber to include or emphasize content categories selected by the subscriber. However, with subscribers having different delivery schedules for a publication or receiving different content, the publisher may want to track which subscribers receive which content pieces in the publication.

Additionally, when subscribers have varied delivery schedules, it is more difficult to time when a subscriber will receive a particular content piece. This may matter for a promotional piece, such as a sales advertisement or coupon. In some cases, a subscriber may receive the promotional piece after the promotion expires.

Further, subscribers often receive the same content pieces within a publication despite having varied interests. As a result, it is challenging to customize a publication for a subscriber. Further, it is challenging to deliver the publication to the subscriber, according to a delivery schedule set by the subscriber, such that the content pieces of the publication are not outdated.

The principles described herein include a method for delivering a customized publication to a subscriber. Such a method includes obtaining, from a content source, a group of currently available content pieces in subscribed content categories for a subscriber, determining if the content pieces in the group are valid or timely, removing any invalid our outdated content pieces from the group to create a group of up-to-date subscribed content pieces, creating a publication with the group of up-to-date subscribed content pieces, and delivering the publication to the subscriber. Such a method allows a publication to be delivered to a subscriber that excludes invalid or outdated content pieces. As a result, the publication that is delivered to the subscriber includes only valid or timely content pieces.

In the present specification and in the appended claims, the term “content source” is meant to be understood broadly as a discrete source for any type of content piece that can be used in a publication. For example, a content source may include a magazine, newspaper, article, website, or the like, or combinations thereof. A content source may provide content pieces in one or several different categories.

In the present specification and in the appended claims, the term “content category” is meant to be understood broadly as a subject area to which content pieces related and are categorized. For example, a content source, such as a newspaper, may include content categories such as an editorial category that includes editorial content pieces, a news report category that includes news report pieces, a weather reports category that include content pieces about weather, a sports category that include content pieces about sports, a business writing category that include content pieces about business writing, a comics category that include content pieces about comics, a coupon category that include coupon content pieces, a promotion category that include content pieces about promotions, other content categories, or combinations thereof.

A subscriber may subscribe to a number of content categories for which the subscriber wants to see individual content pieces. For example, a subscriber may subscribe to news, weather and sports categories.

In the present specification and in the appended claims, the term “content piece” is meant to be understood broadly as discrete article, story or other bit of content. Each content piece may be categorized in a corresponding content category. For example, a content piece such as information about an event that occurred during a specific time and/or a specific place may be categorized in a news report category.

In the present specification and in the appended claims, the term “publication” is meant to be understood broadly as a collection of content pieces in any number of content categories. In a customized or personalized publication, the subscriber will select or subscribe to a number of content categories in which corresponding content pieces will be chosen for inclusion. As noted above and as disclosed herein, a publication includes valid content pieces while excluding content pieces that are still available but that are outdated or otherwise invalid. For example, if a particular content piece has already been distributed to a particular subscriber, that content piece may then be invalid and excluded from further publications compiled for that particular subscriber.

In the present specification and in the appended claims, the term “valid content piece” is meant to be understood broadly as a content piece, from a content category, that may be included in a publication for delivery to a subscriber. In one example, a content piece is determined to be a valid content piece if the content piece has not been delivered to a subscriber in a previous publication, has a valid right to publish, and does not have an expired assigned expiration date.

In the present specification and in the appended claims, the term “invalid content piece” is meant to be understood broadly as any content piece, from a content category, that does not qualify as valid. For example, a content piece is determined to be an invalid content piece if the content piece has been delivered to a subscriber in a previous publication, does not have a valid right to publish, or has an expired assigned expiration date.

In the present specification and in the appended claims, the term “currently available subscribed content categories” is meant to be understood broadly as all content categories, from a content source, that a subscriber has subscribed to and that have content pieces that are available to be delivered in a publication to the subscriber. In one example, the validity of all the content pieces among the currently available subscribed content categories has not been determined for a subscriber. As a result, the currently available subscribed content categories may include both valid content pieces and invalid content pieces.

In the present specification and in the appended claims, the term “subscribed content piece” refers to a content piece from a category to which a subscriber has subscribed.

In the present specification and in the appended claims, the term “group of up-to-date subscribed content pieces” is meant to be understood broadly as a group of valid content pieces, from the currently available subscribed content categories, that are to be delivered in a publication to a subscriber. In one example, the group of up-to-date subscribed sections may include one valid content piece. In another example, the group of up-to-date subscribed sections may include several valid content pieces.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

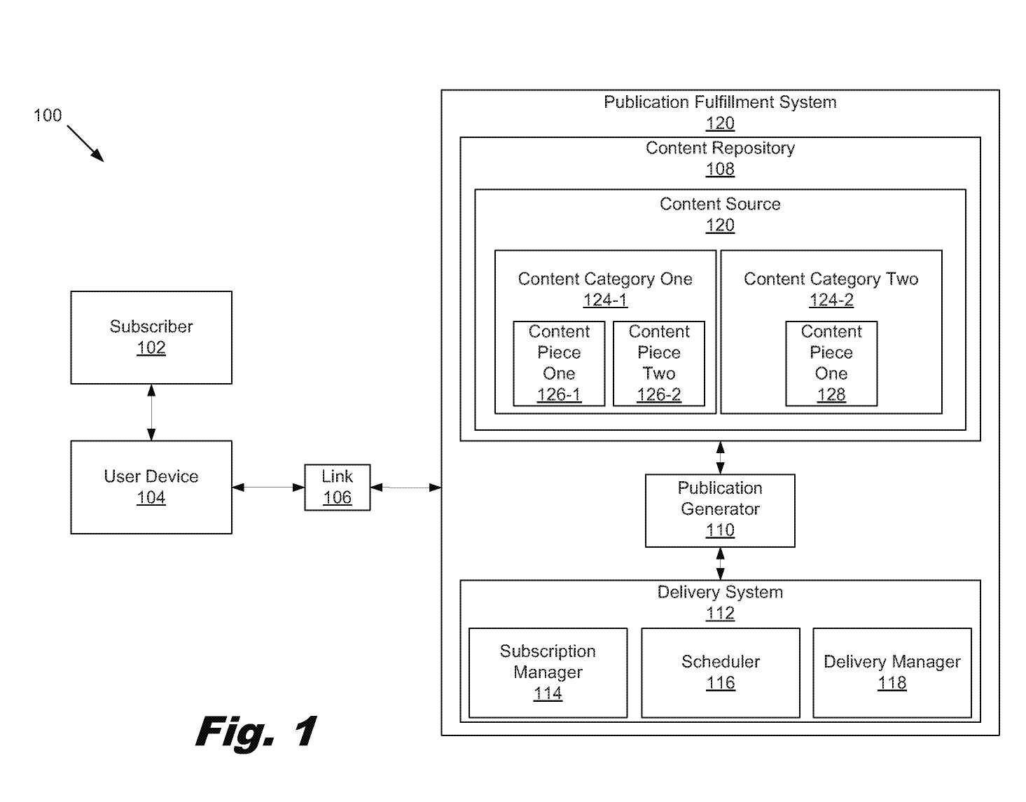

Referring now to the figures, FIG. 1 is a diagram of an illustrative system for delivering a customized publication to a subscriber, according to principles described herein. As will be described below, the system (100) includes a publication fulfillment system (120) that manages and delivers publications to subscribers. The system (100) allows a publication to be delivered to a subscriber that excludes invalid content pieces.

In one example, the subscriber (102) uses a user device (104) to access a link (106) that provides access to the publication fulfillment system (120). The user device (104) may be a computer, smart phone or other electronic device. The link (106) may be a wired or wireless network. In one specific example, the user device (104) may be a web-enabled printer connected to the publication fulfillment system (120) over a link (106) such as the Internet.

In the illustrated example, the publication fulfillment system (120) includes a content repository (108). This content repository (108) may include a content source (120). In this example, the content source (120) may be a discrete source for any type of content piece that can be used in a publication. In keeping with the given example, the content source (120) may be a newspaper.

Further, the content source (120) may include a number of content categories (124). The content categories (124) may be discrete categories for content pieces as explained above. In the illustrated example, the content source (120) includes content category one (124-1) and content category two (124-2). Content category one (124-1) may be, for example, a news report category that includes news reports as content pieces. In the illustrated example, content category one (124-1) includes two content pieces, namely, content piece one (126-1) and content piece two (126-2). In this example, content piece one (126-1) may be information about a news report such as an upcoming music concert. Further, in this example, content piece two (126-2) may be information about an event that just occurred.

In the illustrated example, content category two (124-2) may be a weather reports category that includes weather report or forecast content pieces. In the illustrated example, content category two (124-2) includes a single content piece, namely, content piece one (128). Content piece one (128) may be information about a seven day forecast for a specific city.

A subscriber may subscribe to the content categories (124) via the user device (104). For example, a subscriber may subscribe to content category one (124-1) only, content category two (124-2) only, or both categories. As will be appreciated, this is a simplified example for explanatory purposes. The content source may include a larger number of content categories, each containing any number of content pieces. Also, the content repository may include or have access to any number of such content sources.

Thus, while this example has been described in reference to a subscriber subscribing to several content categories from one content source, a subscriber may subscribe to several content categories from several content sources. For example, a subscriber may subscribe to an editorial category and a coupon category from a magazine and the subscriber may subscribe to an editorial category, a coupon category, and a news report category from a newspaper. More information about a subscriber subscribing to a content category will be described in later parts of this specification.

As illustrated, the publication fulfillment system (120) includes a publication generator (110). The publication generator (110) obtains, from the content source (120) or sources, a group of currently available content pieces from content categories selected by the corresponding subscriber. The publication generator (110) can then exclude any invalid content pieces prior to delivering the publication to the subscriber.

As illustrated, the publication fulfillment system (120) includes a delivery system (112). The delivery system (112) includes a subscription manager (114), a scheduler (116), and a delivery manager (118). In one example, the subscription manager (114) allows the subscriber (102) to subscribe to content categories from a number of content sources (120). The subscription manager (114) then stores information about which content categories (124) the subscriber has selected. For example, if a subscriber (102) subscribes to content category one (124-1), the subscription manager (114), stores information that indicates that the subscriber is subscribed to content category one (124-1). As a result, the subscription manager (114) stores information about subscribed categories for each subscriber.

The scheduler (116) of the delivery system (112) allows the subscriber (102) to select a delivery schedule for the publication. In one example, the subscriber (102) may use the scheduler (116) to select a daily, weekly, bi-weekly or monthly delivery schedule for a publication.

The delivery manager (118) delivers publications to subscribers based on the specific delivery schedule set by each subscriber. Further, the delivery manager (118) ensures that publications delivered to a subscriber include valid content pieces for that subscriber. In one example, a publication may contain the latest versions of content pieces for content categories that a subscriber has subscribed. If a content piece is determined to be an invalid content piece by the publication generator (110), the invalid content piece is not included in the publication. As described in other parts of this specification, an invalid content piece may be based on a right to publish expiration date, a specific period of time since the subscribed sections became available to be delivered to a subscriber, whether the content piece has been sent to the subscriber previously, other factors, or combinations thereof. As a result, a publication excludes invalid content pieces. In the example of FIG. 1, the publication generator (110) may determine content pieces to be valid or invalid based on any combination of the bases described herein for determining whether a content piece is valid or invalid.

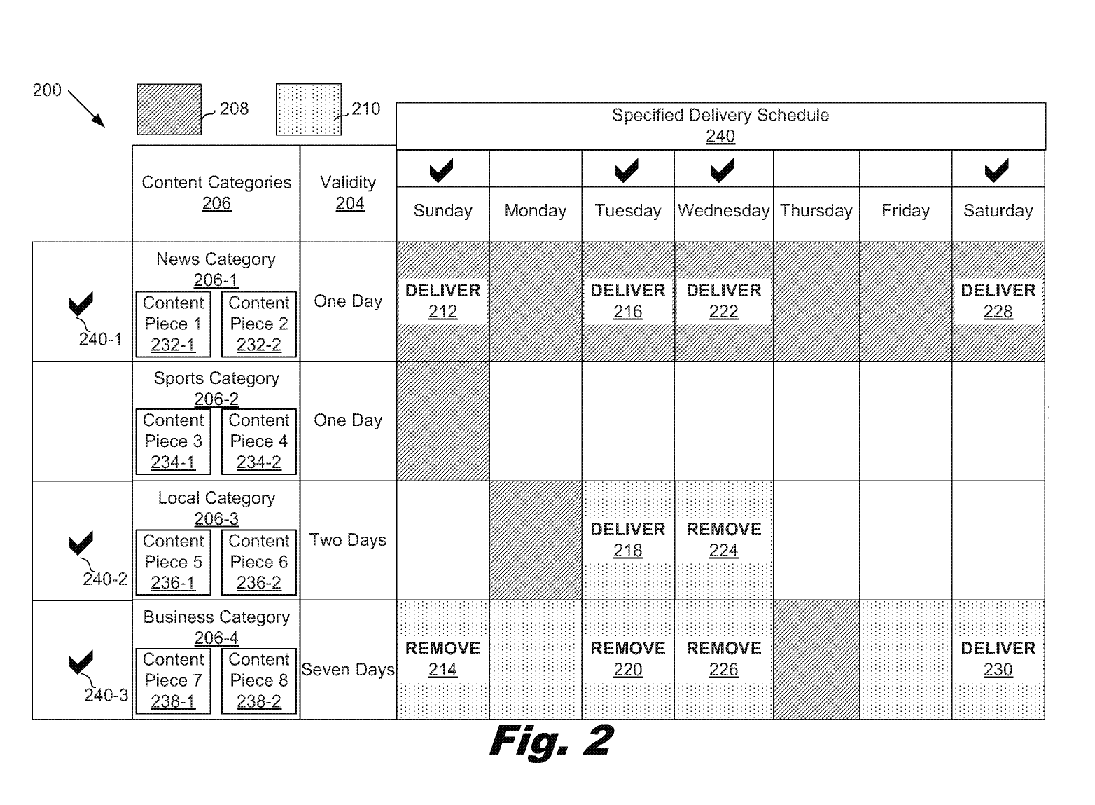

FIG. 2 is a diagram of an example of a delivery schedule (200), according to principles described herein. As mentioned above, a delivery system delivers publications according to a specific delivery schedule set by a subscriber. In one example, the specific delivery schedule may indicate which days to deliver content pieces in a particular category. Consequently, on different days of the week, the publication may be composed of pieces from a different set of content categories.

In the illustrated example, the content categories (206) for a publication may include a news category (206-1), a sports category (206-2), a local category (206-3), and a business category (206-4). As illustrated, the news category (206-1) includes two content pieces (232). For example, content piece 1 (232-1) may be news about an upcoming music concert. Content piece 2 (232-2) may be a news report on an event that has just occurred.

In the illustrated example, the sports category (206-2) includes two content pieces (234). For example, content piece 3 (234-1) may be information about a specific basketball game. Content piece 4 (234-2) may be information about a specific football game.

In the illustrated example, the local category (206-3) includes two content pieces (236) that contain information about local events. For example, content piece 5 (236-1) may be information about a local dance. Content piece 6 (234-2) may be information about a local election.

In the illustrated example, the business category (206-4) includes two content pieces (238) that contain information about business. For example, content piece 7 (238-1) may be information about a new business being opened. Content piece 8 (238-2) may be information about business regulation in a particular jurisdiction.

As mentioned above, a subscription manager allows the subscriber to select desired content categories (206) from at least one content source. In this example, the checkmarks (240) in the first column on the left represent content categories (206) that a subscriber has selected. In the illustrated example, the subscriber is subscribed to the news category (206-1), the local category (206-3), and the business category (206-4), but not the sports category (206-2).

Content pieces (232, 234, 236, 238) in the different content categories (206) may be valid for a specific length of time. In this example, the length of time that the content pieces (232, 234, 236, 238) are valid is shown in a validity column (204). The validity (204) column may indicate that the content pieces (232, 234, 236, 238) are valid for one day, two days, seven days, or combinations thereof. For example, the content pieces (232) for a news category (206-1) are valid for one day. Alternatively, the validity column could specific an expiration date and time after which the corresponding content piece is invalid.

In the illustrated example, the delivery schedule (200) includes a user-selected delivery schedule (240). In this example, the specified delivery schedule (240) dictates when a publication is to be delivered to a subscriber. In the illustrated example, the subscriber has requested to receive a publication on Sunday, Tuesday, Wednesday, and Saturday.

In the illustrated example, a first type (208) of shading on a specific delivery schedule (240) indicates on which days the content categories (206) have new editions of content pieces (232, 234, 236, 238) available for a publication. For example, the news category (206-1) has a new edition of content pieces (232) every day, while the local category (206-3) has a new edition of content pieces (236) available on Mondays and the business category (206-4) has a new edition of content pieces (238) available on Thursdays.

A second type (210) of shading indicates that the pieces (232, 234, 236, 238) for a content category (206) in a publication are valid. For example, the content pieces (236) for the local category (206-3) are valid for two days. In this example, the local category (206-3) is marked as a new edition (208) of content pieces (236) available on Monday. On the subsequent day, the content pieces (236) for the local category (206-3) are no longer new, but are still valid. As a result, the content pieces (236) for the local category (206-3) are marked valid as indicated by the second type (210) of shading.

An example of the specific delivery schedule (240) will now be described with reference to FIG. 2. As mentioned, the system (FIG. 1, 100) obtains, from a content source, a group of currently available content pieces in subscribed categories for a particular subscriber. In this example, the subscriber has subscribed to the news category (206-1), the local category (206-3), and the business category (206-4). As a result, the system (FIG. 1, 100) obtains, from the content source, those content pieces in the news category (206-1), the local category (206-3), and the business category (206-4). Further, the system (FIG. 1, 100) determines invalid content pieces (232, 236, 238) from the group of content pieces available.

In the illustrated example, the delivery of a publication occurs as follows. On Sunday, the content pieces (232) for the news category (206-1) and the content pieces (238) for the business category (206-4) are to be delivered. However, the content pieces (238) for the business category (206-4) are determined to be invalid content pieces since the most recent, valid content pieces were scheduled to be delivered on the previous Saturday. The content pieces (232) for the news category (206-1) are determined to be valid content pieces. In this example, the content pieces (238) for the business category (206-4) are marked as remove (214). As a result, the content pieces (238) for the business category (206-4) are removed. The content pieces (232) for the news category (206-1) remain in the group to be assembled in the publication. The system (FIG. 1, 100) then creates the publication with the group of valid content pieces. In the illustrated example, the content pieces (232) for the news category (206-1) are valid and marked as deliver (212). As a result, a publication with content pieces (232) from the news category (206-1) is delivered to the subscriber.

On Tuesday, the system (FIG. 1, 100) obtains, from a content source, a group of currently available content pieces in categories specified by the subscriber. In keeping with the given example, the subscriber has subscribed to the news category (206-1), the local category (206-3), and the business category (206-4). As a result, the system (FIG. 1, 100) obtains, from a content source, content pieces in the news category (206-1), the local category (206-3), and the business category (206-4). Next, the system (FIG. 1, 100) determines invalid content pieces from the group of currently available content pieces.

On Tuesday, the content pieces (232) for the news category (206-1), the content pieces (236) for the local category (206-3), and the content pieces (238) for the business category (206-4) can be delivered. However, the content pieces (238) for the business category (206-4) are determined to be invalid content pieces since the most recent, valid content pieces were scheduled to be delivered on the previous Saturday. The content pieces (232) for the news category (206-1) and the content pieces (238) for the local section (206-3) are determined to be valid content pieces. In the illustrated example, the content pieces (238) for the business category (206-4) are marked as remove (220). As a result, the content pieces (238) for the business category (206-4) are removed from the group of currently available content pieces. The content pieces (232) for the news category (206-1) and the content pieces (236) for the local section (206-3) remain in the group of up-to-date subscribed content pieces. Therefore, the system (FIG. 1, 100) creates a publication with the group of up-to-date subscribed content pieces. In this example, the content pieces (232) for the news category (206-1) and the content pieces (236) for the local section (206-3) are marked as deliver (216, 218). As a result, the publication with the content pieces (232) for the news category (206-1) and the content pieces (236) for the local section (206-3) are delivered to the subscriber.

On Wednesday, the system (FIG. 1, 100) obtains, from the content source, a group of currently available subscribed content pieces for a subscriber. In this example, the subscriber has subscribed to the news category (206-1), the local category (206-3), and the business category (206-4). As a result, the system (FIG. 1, 100) obtains, from a content source, the content pieces in the news category (206-1), the local category (206-3), and the business category (206-4). Further, the system (FIG. 1, 100) determines invalid content pieces from the group of currently available subscribed content pieces.

On Wednesday, the content pieces (232) for the news category (206-1), the content pieces (236) for the local category (206-3), and the content pieces (238) for the business category (206-4) are to be delivered in the illustrated example. However, the content pieces (236) for the local category (206-3), and the content pieces (238) for the business category (206-4) are determined to be invalid content pieces since the most recent, valid content pieces were previously delivered. But, the content pieces (232) for the news category (206-1) are determined to be valid content pieces. In this example, the content pieces (238) for the business category (206-4) are marked as remove (226). Further, the content pieces (236) for the local category (206-3) are marked as remove (224). As a result, the content pieces (236) for the local category (206-3) and the content pieces (238) for the business category (206-4) are removed from the group of currently available subscribed content pieces to create a group of up-to-date subscribed content pieces. In this example, the content pieces (232) for the news category (206-1) remains in the group of up-to-date subscribed content categories. The system (FIG. 1, 100) further creates a publication with the group of up-to-date subscribed content categories. In this example, the content pieces (232) for the news category (206-1) are marked as deliver (222). As a result, the publication with the content pieces (232) for the news category (206-1) is delivered to the subscriber.

On Saturday, the system (FIG. 1. 100) obtains, from the content source, a group of currently available subscribed content pieces for a subscriber. In this example, the subscriber has subscribed to the news category (206-1), the local category (206-3), and the business category (206-4). As a result, the system (FIG. 1, 100) obtains, from a content source, the content pieces in the news category (206-1), the local category (206-3), and the business category (206-4). Next, the system (FIG. 1, 100) determines invalid content pieces from the group of currently available subscribed content pieces.

On Saturday, the content pieces (232) for the news category (206-1) and the content pieces (238) for the business category (206-4) are to be delivered. Further, the content pieces (232) for the news category (206-1) and the content pieces (238) for the business category (206-4) are determined to be valid content pieces. As a result, no content pieces are removed from the group of currently available subscribed content pieces. The content pieces (232) for the news category (206-1) and the content pieces (238) for the business category (206-4) remain in the group of up-to-date subscribed content pieces. The content pieces (232) for the news category (206-1) are marked as deliver (228) and the content pieces (238) for the business category (206-4) are marked as deliver (230). As a result, the publication with the content pieces (232) for the news category (206-1) and the content pieces (238) for the business category (206-4) is delivered to the subscriber.

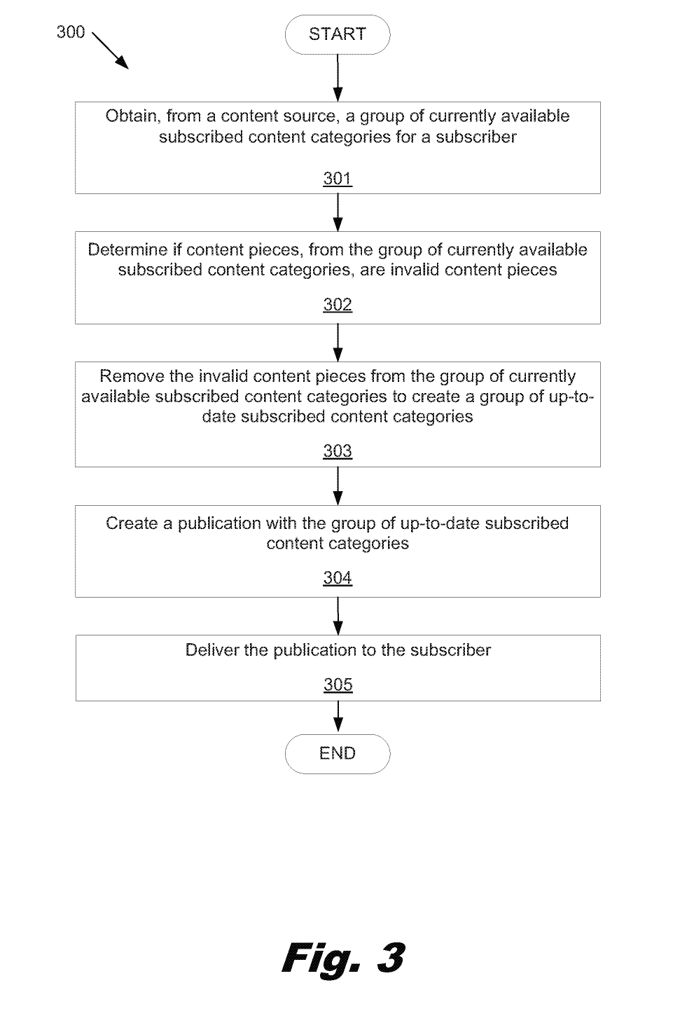

FIG. 3 is a flowchart of an example of a method for delivering a publication to a subscriber, according to principles described herein. In one example, the method (300) may be executed by the system (100) of FIG. 1. In other examples, the method (300) may be executed by other systems described herein (e.g., system 900, system 1000, etc.). In keeping with the given example, the method (300) includes obtaining (301), from a content source, a group of currently available content pieces in categories subscribed by a particular subscriber, determining (302) if content pieces, from the group of currently available subscribed content pieces, are invalid, removing (303) the invalid content pieces from the group of currently available subscribed content pieces to create a group of up-to-date subscribed content pieces, creating (304) a publication with the group of up-to-date content categories, and delivering (305) the publication to the subscriber. In some examples, content pieces may be determined (302) to be valid or invalid based on any combination of the bases described herein for determining whether a content piece is valid or invalid.

As mentioned above, the method (300) includes removing (303) the invalid content pieces from the group of currently available subscribed content pieces to create a group of up-to-date subscribed content pieces. For example, if a content piece has already been delivered to a subscriber previously, it is advantageous to not deliver that content piece to the subscriber again. Thus, once delivered, a content piece is considered invalid for further use in a publication for that same subscriber. This may save a publisher on costs and increase the subscriber's interest in the publication.

In one example, the invalid content pieces may be removed from the group of currently available subscribed content pieces by simply not selecting the invalid content pieces to be included in the group of up-to-date subscribed content pieces in the first place. In another example, the invalid content pieces may be removed from the group of currently available subscribed content pieces by the delivery system of FIG. 1. In some examples, the delivery system of FIG. 1 may display which content pieces are invalid and marked for removal from the group. A user may then confirm or override the removal of invalid content pieces.

As indicated, a content piece may become invalid after a specific period of time since the content piece first became available for possible inclusion in a publication. For example, a content piece, such as an advertisement, may be valid for just one day. Thus, a publication that is to be delivered two days later will not include the advertisement. This allows the system to presently only timely advertisements to subscribers.

As mentioned above, the method (300) includes delivering (305) the publication to a subscriber. In one example, the publication may be delivered to the subscriber electronically, such as over the Internet. Alternatively, the publication may be a hardcopy delivered via regular mail. In another example, a publication may be sent to web connected printer according to a specific delivery schedule. In this example, once the web connected printer receives a publication, the web connected printer prints the publication. Any appropriate mechanism may be used to deliver the publication to the subscriber.

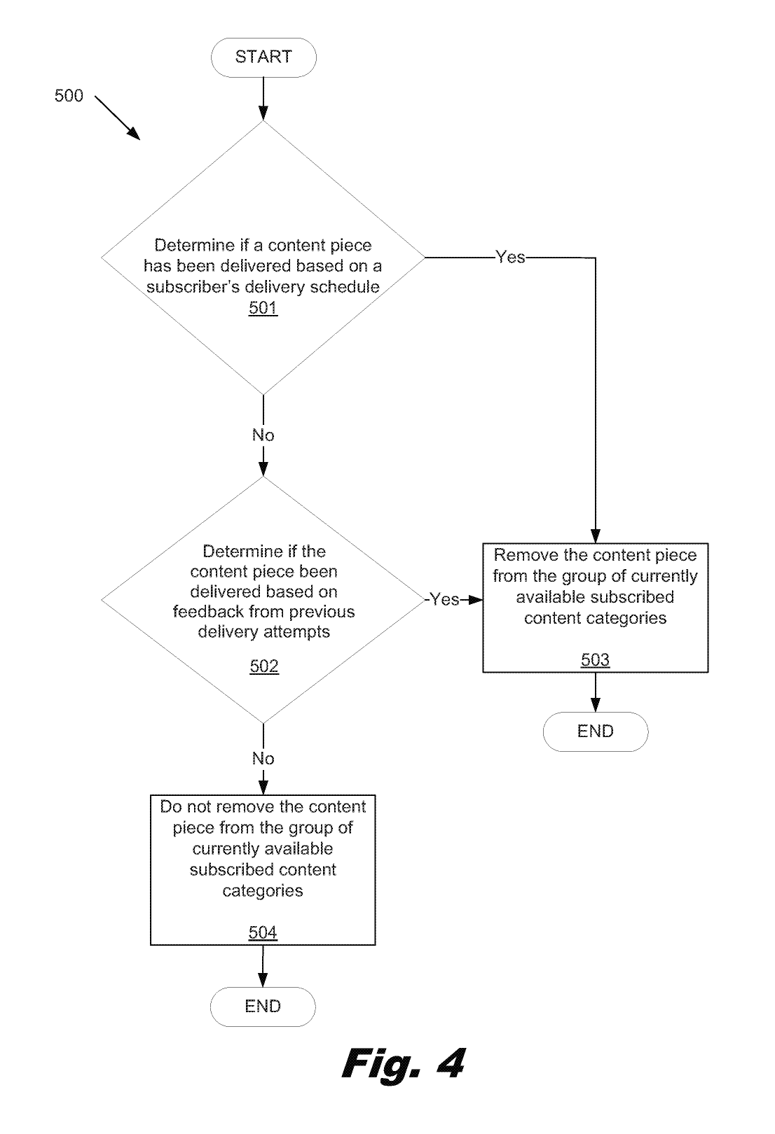

FIG. 4 is a flowchart of an example of one method for removing invalid content pieces from possible inclusion in a publication. In one example, the method (500) may be executed by the system (100) of FIG. 1. In other examples, the method (500) may be executed by other systems described herein (e.g., system 900, system 1000, etc.). The method (500) includes determining (501) if a content piece has been delivered previously to a particular subscriber based on that subscriber's delivery schedule. If it has, that content piece is then removed from possible inclusion in the publication being assembled.

However, if the content piece was not previously delivered to the subscriber based on a delivery schedule of the subscriber, the content piece is further evaluated. As a result, the method (500) further includes determining (502) if the content piece has been delivered based on feedback from previous delivery attempts.

In one example, the publication fulfillment system (120) of FIG. 1 may receive feedback from a subscriber to determine if previous delivery attempts were made. For example, if a content piece was delivered to a subscriber, the subscriber may indicate to the system that the content piece was delivered. Specifically, the subscriber may provide feedback indicating that the content piece was delivered by taking an online survey using a user device. Alternatively, if the online survey is not completed by the subscriber, the publication fulfillment system (FIG. 1, 120) may presume that the content piece was not delivered to the subscriber.

Thus, the method (500) further includes determining (502) if the content piece has been delivered based on feedback from previous delivery attempts. If yes, then the content piece is invalid and removed (504) from possible inclusion in the publication being assembled. If user feedback does not indicate that the content piece was previously delivered, that content piece remains valid and is not removed (504) from the group of available content pieces that might be used to assemble the upcoming publication.

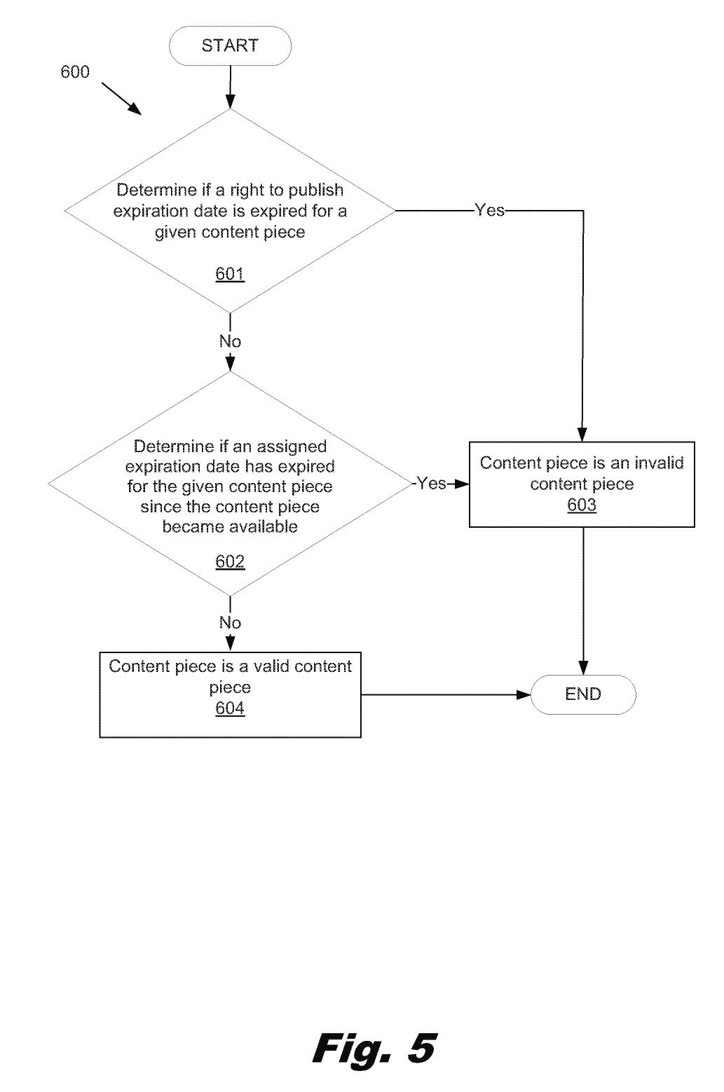

FIG. 5 is a flowchart of an example of another method for determining if a content piece is a valid content piece for a subscriber, according to principles described herein. In one example, the method (600) may be executed by the system (100) of FIG. 1. In other examples, the method (600) may be executed by other systems described herein (e.g., system 900, system 1000, etc.). In one example, the method includes determining (601) if a right to publish expiration date is expired for a given content piece, and determining (602) if an assigned expiration date has expired for the given content piece since the content piece became available. The right to publish expiration date may be based on the rights given to offer the content piece to subscribers, while the assigned expiration date may indicate when the information in the corresponding content piece has become date or irrelevant irrespective of the right to still publish that content piece. Thus, a content piece may still be relevant and of interest when a right to publish expiration date occurs. Another content piece may still be available for publication, but is out of date and irrelevant.

As mentioned above, the method (600) includes determining (601) if a right to publish expiration date is expired for a given content piece. In one example, if a right to publish expiration date is expired for a given content piece, the content piece is an invalid content piece (603). However, if the right to publish expiration date is not expired for a given content piece, the method (600) includes determining (602) if an assigned expiration date has expired for the given content piece since the content piece became available.

In one example, the assigned expiration date for the given content piece since the content piece became available may be a day, a week, a month, or variations thereof. In this example, if the assigned expiration date for the given content piece since the content piece became available has expired, the content piece is an invalid content piece (603). However, if the assigned expiration date for the given content piece since the content piece became available has not expired, the content piece is a valid content piece (604).

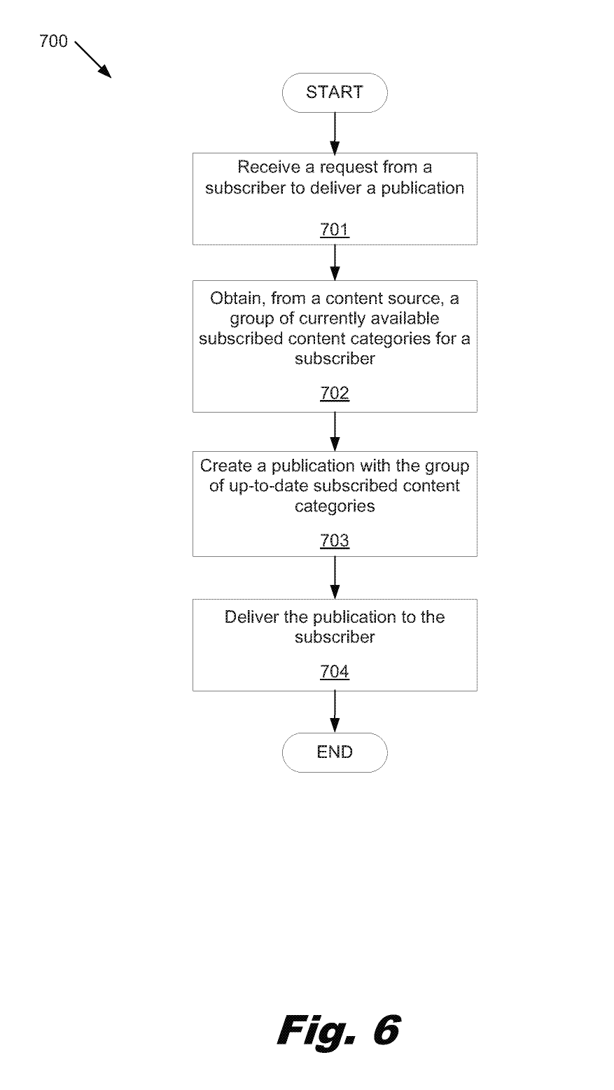

A specific example will now be described with reference to FIG. 6. In this example, a content piece, such as an opinion column, is assigned a right to publish expiration date of one day after the content piece became available. In this example, if more than a day has passed since the opinion column became available, it is an invalid content piece even though it may still be of interest to subscribers.

In yet another example, a content piece, such as a Monday update bulletin, has an assigned expiration date of Monday at 11:59 pm. In this example, if the assigned expiration date for the Monday update bulletin has expired, the bulletin will be an invalid content piece. As such, the bulletin will not be included in a publication, even though the right to publish it may still exist.

FIG. 6 is a flowchart of an example of a method for delivering a publication, according to principles described herein. In one example, the method (700) may be executed by the system (100) of FIG. 1. In other examples, the method (700) may be executed by other systems described herein (e.g., system 900, system 1000, etc.). In one example, the method (700) includes receiving (701) a request from a subscriber to deliver a publication, obtaining (702), from a content source, a group of currently available subscribed content pieces for a subscriber, creating (703) a publication with a group of up-to-date subscribed content pieces, and delivering (704) the publication to the subscriber. In the example of FIG. 6, valid content pieces to be included in the group of up-to-date subscribed content pieces may be determined (702) based on any combination of the bases described herein for determining whether a content piece is valid or invalid.

As mentioned above, the method (700) includes receiving (701) a request from a subscriber to deliver a publication. In one example, a subscriber may request, using a user device, to deliver a publication according to a specified delivery schedule or the publication may be assembled and delivered on-demand when requested by the subscriber.

In various examples, the user may request delivery of the publication every Monday and Thursday. In another example, the user may request delivery of the publication every Monday, Wednesday, and Friday. In another example, the subscriber may request delaying delivery of a publication. In this example, the publication may be delivered outside of a delivery schedule that the subscriber has specified.

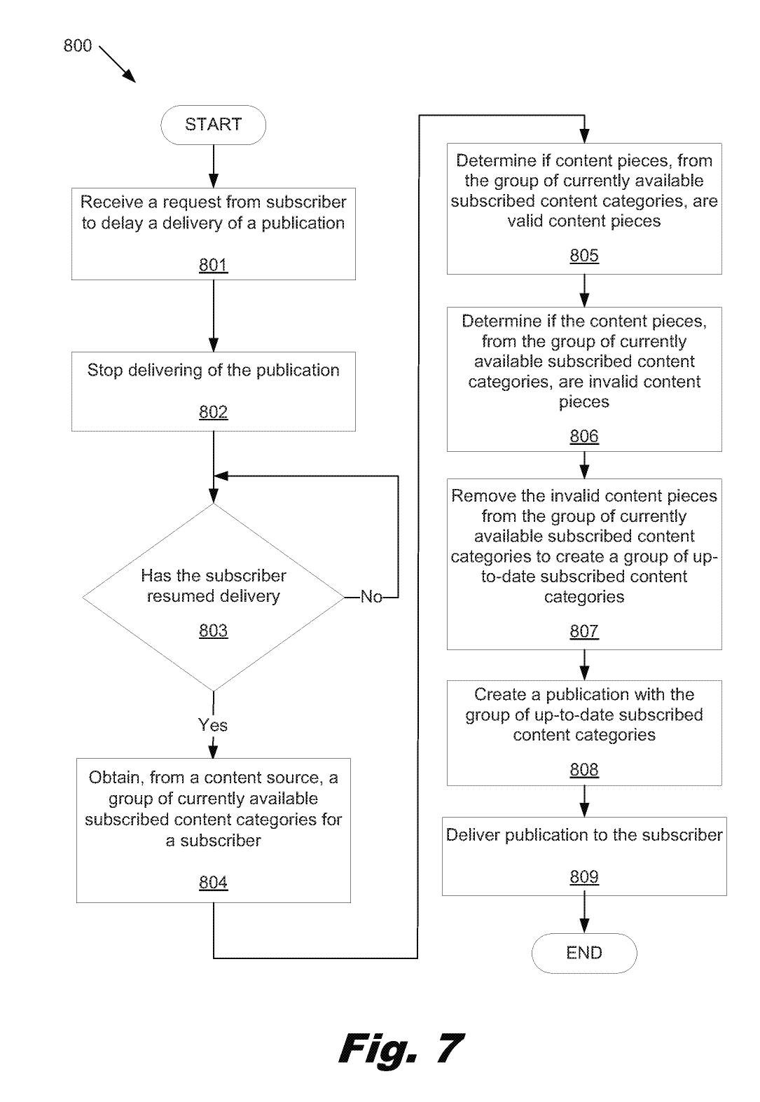

FIG. 7 is a flowchart of an example of a method for delaying delivery of a publication, according to principles described herein. In one example, the method (800) may be executed by the system (100) of FIG. 1. In other examples, the method (800) may be executed by other systems described herein (e.g., system 900, system 1000, etc.). In one example, the method (800) includes receiving (801) a request from a subscriber to delay a delivery of a publication, stopping (802) delivering of the publication, determine if the subscriber (803) has resumed delivery. If it is determined that the subscriber (803) has resumed delivery, the method further includes obtaining (804), from a content source, a group of currently available subscribed content pieces for a subscriber; determining (805) if the content pieces are valid content pieces; or determining (806) if the content pieces are invalid content pieces; removing (807) the invalid content pieces from the group; creating (808) a publication with the group of valid content pieces; and delivering (809) the publication to the subscriber.

In one example, the subscriber may use a user device to request a delay in delivery of the publication. The subscriber may request a delay in delivery of the publication due to a vacation. As a result, the delivery of the publication is stopped (802). The method then determines if the subscriber (803) has resumed delivery. If the subscriber has not resumed delivery, the delivery of the publication is stopped. Upon resuming the delivery of a publication, the method (800) further includes obtaining (804), from a content source, a group of currently available subscribed content pieces for a subscriber. The method (800) further includes, determining (805) if content pieces are valid content pieces and/or determining (806) if the content pieces are invalid content pieces. In the example of FIG. 7, content pieces may be determined (805) to be valid or invalid based on any combination of the bases described herein for determining whether a content piece is valid or invalid. Still further, the method (800) includes removing (807) the invalid content pieces from the group. The method (800) then creates (808) a publication with the group of up-to-date content pieces and delivers (809) the publication to the subscriber. As a result, after the subscriber returns from a vacation, the subscriber is not inundated with a backlog of old articles and content pieces.

Further, in one example, delivering (809) the publication to the subscriber may include delivering the publication outside of a specific delivery schedule. For example, upon resuming the delivery of a publication after the subscriber stopped (802) delivery of the publication, the system (FIG. 1, 100) may determine that it is advantageous to deliver the publication on Tuesday instead of Thursday according to the specific delivery schedule. In this example, the publication may include a content piece that may be of interest to the subscriber. However, the content piece of interest to the subscriber is a valid content piece only on Tuesday and Wednesday. As a result, the publication is delivered to the subscriber outside of the specific delivery schedule to ensure the content piece in the publication is a valid content piece.

FIG. 8 is a diagram of an example of a delivery system. The delivery system (900) includes an obtaining engine (902), a validity determining engine (904), a removing engine (906), a creating engine (908), and a delivering engine (910). In this example, the delivery system (900) also includes an immediate delivering engine (912). The engines (902, 904, 906, 908, 910, 912) refer to a combination of hardware and program instructions to perform a designated function. Each of the engines (902, 904, 906, 908, 910, 912) may include a processor and memory. The program instructions are stored in the memory and cause the processor to execute the designated function of the engine.

The obtaining engine (902) obtains, from a content source, a group of currently available subscribed content pieces for a subscriber. In one example, the group of currently available content pieces for a subscriber is obtained from one content source or multiple content sources. Further, a subscriber may choose from which currently available subscribed content categories the obtaining engine (902) will obtain content pieces.

The validity determining engine (904) determines if content pieces, from the group of currently available subscribed content categories, are valid content pieces. The validity determining engine (904) may distinguish between valid and invalid content pieces based on any combination of the different bases described above for determining whether a content piece is valid or invalid (including, for example, the bases described above in relation to FIGS. 4 and 5).

The removing engine (906) removes any invalid content pieces from the group of currently available subscribed content pieces to create a group of up-to-date or valid subscribed content pieces. As a result, when the removing engine (906) has removed the invalid content pieces from the group, only valid content pieces remain in the group for inclusion in a publication.

The creating engine (908) then creates a publication with the group of up-to-date subscribed content pieces. The creating engine (908) may order the content pieces by category or in some other fashion. This may be dictated by preferences indicated by the subscriber.

The delivering engine (910) delivers the publication to the subscriber. As noted above, the delivery may be based on a specific delivery schedule that is specified by the subscriber. Further, the delivery of the publication may be made to a user device such as a computer, to a printer connected to the user device, a web connected printer, a mobile phone, tablet, other devices, or combinations thereof. In one example, a publication may be delivered via a web connected printer according to a specific delivery schedule. In this example, once the web connected printer receives a publication, the web connected printer prints the publication.

The immediate delivering engine (912) delivers the publication outside of a specific delivery schedule. In one example, the immediate delivering engine (912) delivers one publication to a subscriber. In another example, the immediate delivering engine (912) delivers several publications to a subscriber.

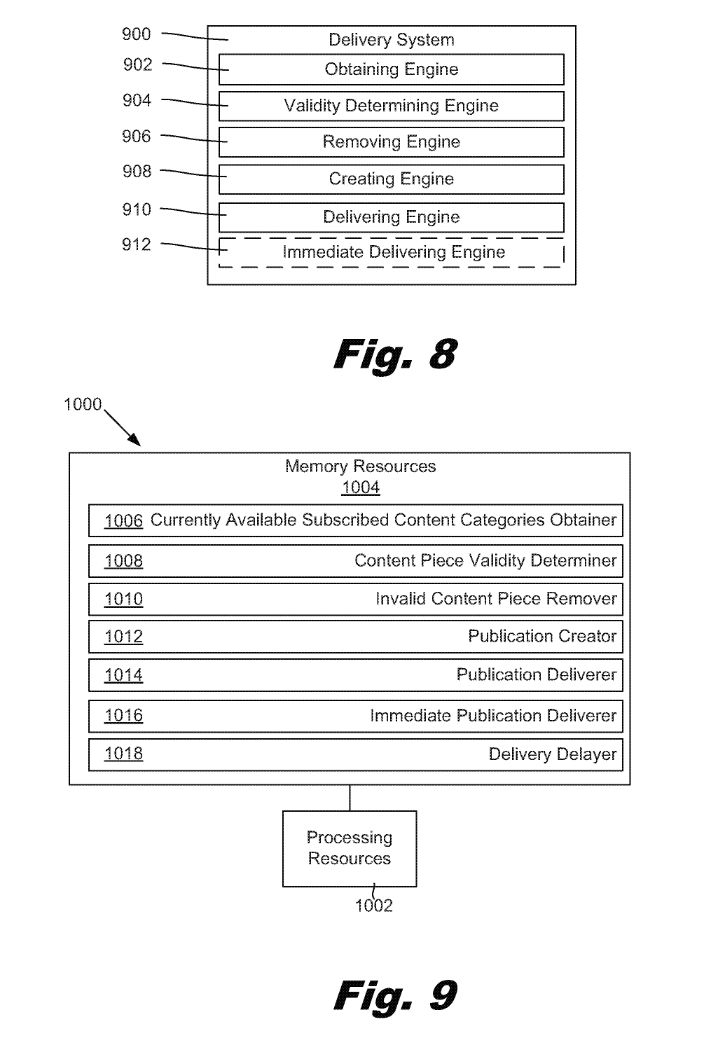

FIG. 9 is a diagram of an example of a delivery system, according to principles described herein. In this example, the delivery system (1000) includes processing resources (1002) that are in communication with memory resources (1004). Processing resources include at least one processor and other resources used to process programmed instructions. The memory resources represent generally any memory capable of storing data such as programmed instructions or data structures used by the delivery system (1000). The programmed instructions shown stored in the memory resources include a currently available subscribed content category obtainer (1006), a content piece validity determiner (1008), an invalid content piece remover (1010), a publication creator (1012), a publication deliverer (1014), an immediate publication deliverer (1016), and a delivery delayer (1018).

The memory resources (1004) include a computer readable storage medium that contains computer readable program code to cause tasks to be executed by the processing resources. The computer readable storage medium may be tangible and/or physical storage medium. The computer readable storage medium may be any appropriate non-transitory storage medium. A non-exhaustive list of computer readable storage medium types includes non-volatile memory, volatile memory, random access memory, write only memory, flash memory, electrically erasable program read only memory, or types of memory, or combinations thereof.

The currently available subscribed content category obtainer (1006) represents programmed instructions that, when executed, cause the processing resources (1002) to obtain, from a content source, a group of currently available subscribed content pieces for a subscriber. The content piece validity determiner (1008) represents programmed instructions that, when executed, cause the processing resources (1002) to determine the validity of a content piece for a subscriber. In the example of FIG. 9, the instructions of content piece validity determiner (1008), when executed, may determine the validity of a content piece for a subscriber based on any combination of the bases described herein for determining whether a content piece is valid or invalid (including, for example, the bases described above in relation to FIGS. 4 and 5). The invalid content piece remover (1010) represents programmed instructions that, when executed, cause the processing resources (1002) to remove invalid content pieces from the group of currently available subscribed content categories.

The publication creator (1012) represents programmed instructions that, when executed, cause the processing resources (1002) to create a publication with the group of up-to-date subscribed content pieces. The publication deliverer (1014) represents programmed instructions that, when executed, cause the processing resources (1002) to deliver the publication to the subscriber. The immediate publication deliverer (1016), represents programmed instructions that, when executed, cause the processing resources (1002) to deliver the publication outside of a specific delivery schedule. The delivery delayer (1018) represents programmed instructions that, when executed, cause the processing resources (1002) to delay the delivery of a publication.

Further, the memory resources (1004) may be part of an installation package. In response to installing the installation package, the programmed instructions of the memory resources (1004) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, o the like.

In some examples, the processing resources (1002) and the memory resources (1002) are located within the same physical component, such as a server, or a network component. The memory resources (1004) may be part of the physical component's main memory, caches, registers, non-volatile memory, or elsewhere in the physical component's memory hierarchy. Alternatively, the memory resources (1004) may be in communication with the processing resources (1002) over a network, Further, the data structures, such as the libraries, may be accessed from a remote location over a network connection while the programmed instructions are located locally. Thus, the delivery system (1000) may be implemented on a user device, on a server, on a collection of servers, or combinations thereof.

The delivery system (1000) of FIG. 9 may be part of a general purpose computer. However, in alternative examples, the delivery system (1000) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for delivering a publication to a subscriber, the method comprising:
obtaining, from a content source, a group of currently available subscribed content pieces for a subscriber;
determining if content pieces, from the group of currently available subscribed content pieces, are invalid content pieces;
removing any invalid content pieces from the group;
creating a publication with content pieces remaining in the group; and
delivering the publication to the subscriber.

2. The method of claim 1, wherein determining if a content piece is invalid further comprises determining whether that content piece has an expired right to publish expiration date.

3. The method of claim 1, wherein determining if a content piece is invalid is based on a specific period of time since that content piece became available for delivery to the subscriber.

4. The method of claim 1, wherein determining if a content piece is invalid is based on assigned expiration date for that content piece.

5. The method of claim 1, wherein determining if a content piece is invalid further comprises determining if that content piece was previously delivered to the subscriber.

6. The method of claim 5, wherein determining if a content piece was previously delivered to a subscriber is performed based on a delivery schedule of the subscriber.

7. The method of claim 5, wherein determining if a content piece was previously delivered to a subscriber is performed based on feedback from surveying the subscriber.

8. The method of claim 1, in which delivering the publication to the subscriber further comprises delivering the publication outside of a specified delivery schedule.

9. The method of claim 1, in which delivering the publication to the subscriber comprises delivering the publication electronically over a computer network.

10. A system for delivering a publication to a subscriber, the system comprising:
an obtaining engine to obtain, from a content source, a group of currently available subscribed content pieces for a subscriber;
a validity determining engine to determine if content pieces in the group are valid content pieces.
a removing engine to remove any invalid content pieces from the group;
an creating engine to create a publication with remaining content pieces in the group; and
a delivering engine to deliver the publication to the subscriber.

11. The system of claim 10, in which the validity determining engine is to further determine if any of the content pieces were previously delivered to the subscriber based on a delivery schedule of the subscriber.

12. The system of claim 10, further comprising an immediate delivering engine to deliver the publication outside of a specified delivery schedule.

13. The system of claim 10, in which the validity determining engine is to further determine if the content pieces were previously delivered to the subscriber based on feedback from previous delivery attempts to the subscriber.

14. A computer program product for delivering a publication to a subscriber, comprising:
a tangible computer readable storage medium, said tangible computer readable storage medium comprising computer readable program code embodied therewith, said computer readable program code comprising program instructions that, when executed, causes a processor to:
obtain, from a content source, a group of currently available subscribed content pieces for a subscriber;
determine if the content pieces are invalid content pieces;
remove any invalid content pieces from the group; and
create a publication with remaining content pieces from the group for delivery to the subscriber.

15. The product of claim 14, further comprising computer readable program code comprising program instructions that, when executed, cause said processor to deliver the publication to the subscriber via a computer network.
